(19) United States
(12) Patent Application Publication
(10) Pub. No.: US 2025/0116012 A1
(43) Pub. Date: Apr. 10, 2025

(54) FLUID CONTAINER AND ELECTROCHEMICAL CELL

(71) Applicant: NGK INSULATORS, LTD., Nagoya-shi (JP)

(72) Inventors: Takashi SHIRATORI, Nagoya-shi (JP); Toshiyuki NAKAMURA, Handa-shi (JP); Genta TERAZAWA, Nagoya-shi (JP); Makoto OHMORI, Nagoya-shi (JP)

(21) Appl. No.: 18/640,384

(22) Filed: Apr. 19, 2024

Related U.S. Application Data
(63) Continuation of application No. PCT/JP2023/036376, filed on Oct. 5, 2023.

(51) Int. Cl. C25B 9/60

(52) U.S. Cl. CPC C25B 9/60

(57) ABSTRACT

The present fluid container includes a first metallic member, a second metallic member, an adherence par, a first interface, and a second interface. Each of the first and second metallic members contains chromium. The adherence part is made of an oxide containing chromium as a primary component. The adherence part adheres the first metallic member and the second metallic member to each other. The first interface is provided as an interface between the first metallic member and the adherence part. The second interface is provided as an interface between the second metallic member and the adherence part. The first interface includes a first wavy portion. The first wavy portion repeatedly winds in a thickness direction. The first wavy portion extends along an outer peripheral edge of the first metallic member.

### CROSS-REFERENCE TO RELATED APPLICATION

This is a continuation of PCT/JP2023/036376, filed Oct. 5, 2023, the entire contents of which are hereby incorporated by reference.

### TECHNICAL FIELD

The present invention relates to a fluid container and an electrochemical cell.

### BACKGROUND ART

Electrochemical cells such as electrolytic cells and fuel cells include a fluid container to supply a fluid to a cell body thereof. For example, a fluid container disclosed in JP2015-156352A includes a first inter-connector, a second inter-connector, a separator, a fuel electrode frame, and a glass seal.

The first inter-connector is connected to an air electrode of a fuel cell. The second inter-connector is connected to a fuel electrode-side electricity collecting layer of the fuel cell. The separator is connected to a solid electrolyte of the fuel cell and divides a channel for fuel gas and that for oxidant gas from each other. The fuel electrode frame is disposed between the separator and the second inter-connector. The glass seal adheres the first inter-connector and the separator to each other.

### SUMMARY OF THE INVENTION

### Technical Problems

In such a fluid container as described above, a first metallic member and a second metallic member are adhered to each other by an adherence part. In the fluid container, it is concerned that a difference in thermal expansion is caused between the first and second metallic members due to such a reason as a thermal cycle caused with activation and deactivation of the electrochemical cell and results in concentration of a load on the adherence part, whereby the adherence part is damaged or broken.

It is an object of the present invention to provide a fluid container and an electrochemical cell, whereby damage or breakage of an adherence part can be inhibited.

### Solution to Problems

A fluid container according to a first aspect includes a first metallic member, a second metallic member, an adherence part, a first interface, and a second interface. The first metallic member contains chromium. The second metallic member contains chromium. The adherence part is made of an oxide containing chromium as a primary component. The adherence part adheres the first and second metallic members to each other. The first interface is provided as an interface between the first metallic member and the adherence part. The second interface is provided as an interface between the second metallic member and the adherence part. The first interface includes a first wavy portion. The first wavy portion repeatedly winds in a thickness direction thereof. The first wavy portion extends along an outer peripheral edge of the first metallic member.

According to the configuration, a stress acting on the adherence part is dispersed by the first wavy portion on the first interface of the adherence part, whereby damage or breakage of the adherence part can be inhibited.

A fluid container according to a second aspect relates to the fluid container according to the first aspect and is configured as follows. The second interface includes a second wavy portion. The second wavy portion repeatedly winds in a width direction thereof. The second wavy portion extends along an outer peripheral edge of the second metallic member.

A fluid container according to a third aspect relates to the fluid container according to the first or second aspect and is configured as follows. The first wavy portion is greater in amount of variation at an outer peripheral edge thereof than at an inner peripheral edge thereof.

A fluid container according to a fourth aspect relates to the fluid container according to any of the first to third aspects and is configured as follows. The first adherence part includes an unfilled portion.

A fluid container according to a fifth aspect relates to the fluid container according to any of the first to fourth aspects and is configured as follows. The first wavy portion has an amount of variation of greater than or equal to 1 μm and less than or equal to 50 μm.

A fluid container according to a sixth aspect relates to the fluid container according to the second aspect and is configured as follows. The first wavy portion has an amount of variation of greater than or equal to 1 μm and less than or equal to 50 μm. The second wavy portion has an amount of variation of greater than or equal to 1 μm and less than or equal to 50 μm.

A fluid container according to a seventh aspect relates to the fluid container according to any of the first to sixth aspects and further includes an internal space through which a fluid flows. The adherence part annularly extends to enclose the internal space.

A fluid container according to an eighth aspect relates to the fluid container according to any of the first to seventh aspects and further includes an internal space through which a fluid flows. The adherence part is a seal for sealing the internal space.

An electrochemical cell according to a ninth aspect includes the fluid container recited in any of the first to eighth aspects and a cell body disposed on the fluid container.

An electrochemical cell according to a tenth aspect relates to the electrochemical cell according to the ninth aspect and is configured as follows. The fluid container includes an internal space through which a fluid flows. The first metallic member includes a plurality of communicating holes continuing to the internal space. The cell body is disposed on the first metallic member to cover the plurality of communicating holes.

An electrochemical cell according to an eleventh aspect relates to the electrochemical cell according to the ninth aspect and is configured as follows. The fluid container includes an internal space through which a fluid flows. The second metallic member includes a plurality of communicating holes continuing to the internal space. The cell body is disposed on the second metallic member to cover the plurality of communicating holes.

### Advantageous Effects of Invention

According to the present invention, damage or breakage of an adherence part can be inhibited.

### BRIEF DESCRIPTION OF THE DRAWINGS

FIG. 1 is a plan view of an electrolytic cell.

FIG. 2 is a cross-sectional view of FIG. 1 taken along line II-II.

FIG. 3 is a cross-sectional view of FIG. 1 taken along line III-III.

FIG. 4 is a plan view of a fluid container.

FIG. 5 is a diagram exemplifying a scanned image.

FIG. 6 is an enlarged cross-sectional view of a first adherence part according to a modification.

FIG. 7 is an enlarged cross-sectional view of the first adherence part according to another modification.

### DESCRIPTION OF EMBODIMENTS

### <Electrolytic Cell>

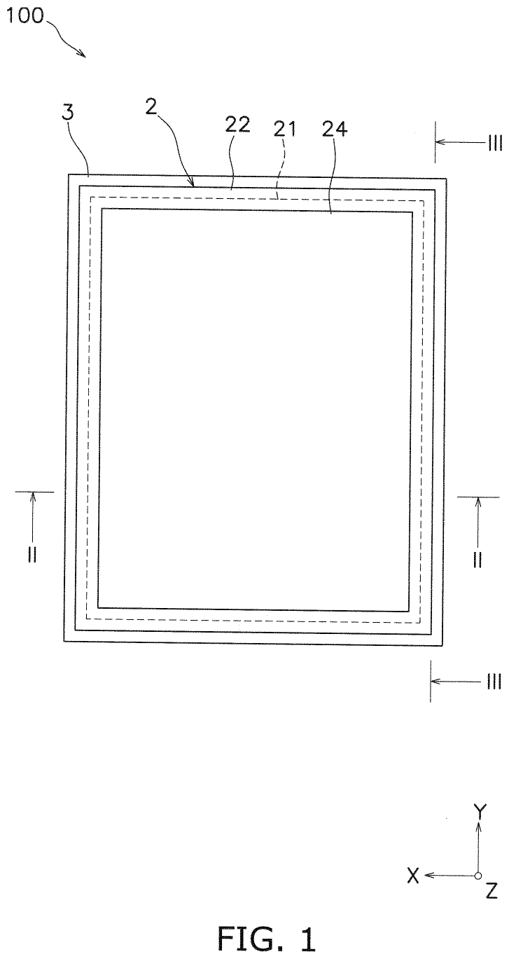

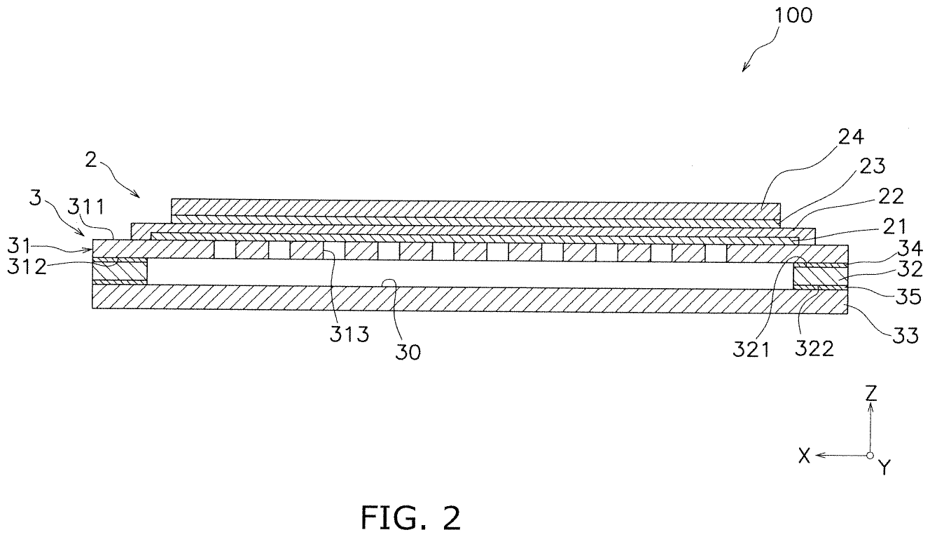

FIG. 1 is a plan view of an electrolytic cell 100. FIG. 2 is a cross-sectional view of FIG. 1 taken along line II-II.

As shown in FIG. 1, the electrolytic cell 100 (exemplary electrochemical cell) is made in shape of a plate extending in an X-axis direction and a Y-axis direction. In the present preferred embodiment, when seen in a plan view along a Z-axis direction perpendicular to both the X-axis and Y-axis directions, the electrolytic cell 100 is made in shape of a rectangle elongated in the Y-axis direction. However, the planar shape of the electrolytic cell 100 is not particularly limited to a specific shape, and hence, may be any shape other than the rectangle, such as a polygon, an ellipse, or a circle.

As shown in FIGS. 1 and 2, the electrolytic cell 100 includes a cell body 2 and a fluid container 3.

### <Cell Body>

The cell body 2 is disposed on the fluid container 3. The cell body 2 is supported by a metallic support 31 (to be described) composing part of the fluid container 3. The cell body 2 is disposed on the metallic support 31 to cover a plurality of communicating holes 313 (to be described). The cell body 2 includes a hydrogen electrode 21 (cathode), an electrolyte 22, a reaction preventing layer 23, and an oxygen electrode 24 (anode).

The hydrogen electrode 21, the electrolyte 22, the reaction preventing layer 23, and the oxygen electrode 24 are laminated in this order from the fluid container 3 side along the Z-axis direction. The hydrogen electrode 21, the electrolyte 22, and the oxygen electrode 24 are essential components; however, the reaction preventing layer 23 is a component provided on an arbitrary basis.

### <Hydrogen Electrode>

The hydrogen electrode 21 is disposed on a first principal surface 311 of the metallic support 31. The hydrogen electrode 21 is supplied with raw material gas from each of the communicating holes 313 of the metallic support 31. The raw material gas contains at least water vapor (H₂O). The hydrogen electrode 21 generates H₂ with electrolytic reactions.

When the raw material gas contains only H₂O, the hydrogen electrode 21 generates H₂ from the raw material gas by electrochemical reactions of water electrolysis expressed in the following formula (1).

Hydrogen electrode 21:H₂0+2e⁻→H₂+O²⁻ (1)

When the raw material gas contains CO₂ in addition to H₂O, the hydrogen electrode 21 generates H₂, CO, and O²⁻ from the raw material gas by electrochemical reactions of co-electrolysis expressed in the following formulae (2), (3), and (4).

Hydrogen electrode 21:CO₂+H₂O+4e⁻→CO+H₂+2O²⁻ (2)

Electrochemical reaction of H₂O:H₂O+2e⁻→H₂+O²⁻ (3)

Electrochemical reaction of CO₂:CO₂+2e⁻→CO+O²⁻ (4)

H₂ generated in the hydrogen electrode 21 flows out through each of the communicating holes 313 of the metallic support 31 to an internal space 30 (to be described).

The hydrogen electrode 21 is a porous body with electronic conductivity. The hydrogen electrode 21 contains nickel (Ni). In co-electrolysis, Ni functions not only functions as an electron transmitter but also functions as a thermal catalyst that maintains a gas composition appropriate for methanation, FR (Fischer-Tropsch) synthesis, and so forth by promoting thermal reactions between He to be generated and CO₂ contained in the raw material gas. During operating the electrolytic cell 100, Ni contained in the hydrogen electrode 21 basically exists in a state of metal (Ni) but may exist in part in a state of nickel oxide (NiO).

The hydrogen electrode 21 may contain an ionic conductive material. For example, the following can be used as the ionic conductive material: one selected from the group of yttria-stabilized zirconia (YSZ), calcia-stabilized zirconia (CSZ), scandia-stabilized zirconia (ScSZ), gadolinium-doped ceria (GDC), samarium-doped ceria (SDC), (La, Sr)(Cr, Mn)O₃, (La, Sr)TiO₃, Sr₂(Fe, Mo)₂O₆, (La, Sr)VO₃, and (La, Sr)FeO₃, a mixed material obtained by a combination of two or more of the group, or so forth.

The hydrogen electrode 21 is not particularly limited in thickness, and hence, can be set to have a thickness of, for instance, greater than or equal to 1 μm and less than or equal to 100 μm. The hydrogen electrode 21 is not particularly limited in thermal expansion coefficient, and hence, can be set to have a thermal expansion coefficient of, for instance, greater than or equal to 12×10⁻⁶/° C. and less than or equal to 20×10⁻⁶/° C.

The hydrogen electrode 21 is not particularly limited in method of formation, and hence, can be formed by any of the methods such as firing, spray coating (thermal spraying, aerosol deposition, aerosol gas deposition, powder jet deposition, particle jet deposition, cold spraying, etc.), PVD (spattering, pulse laser deposition, etc.), and CVD.

### <Electrolyte>

The electrolyte 22 is formed on the hydrogen electrode 21. The electrolyte 22 is disposed between the hydrogen electrode 21 and the oxygen electrode 24. In the present preferred embodiment, the electrolyte 22 is connected to both the hydrogen electrode 21 and the reaction preventing layer 23, while being interposed therebetween.

The electrolyte 22 not only covers the hydrogen electrode 21 but also covers a region, exposed without being covered with the hydrogen electrode 21, on the first principal surface 311 of the metallic support 31.

The electrolyte 22 is a dense body with oxide ionic conductivity. The electrolyte 22 transmits O²⁻, generated in the hydrogen electrode 21, to the oxygen electrode 24 side. The electrolyte 22 is made of an oxide ionic conductive material. The electrolyte 22 can be made of, for instance, YSZ, GDC, ScSZ, SDC, LSGM (lanthanum gallate), or so forth but is preferably made of YSZ.

The electrolyte 22 is not particularly limited in thickness, and hence, can be set to have a thickness of, for instance, greater than or equal to 1 μm and less than or equal to 100 μm. The electrolyte 22 is not particularly limited in thermal expansion coefficient, and hence, can be set to have a thermal expansion coefficient of, for instance, greater than or equal to 10×10⁻⁶/° C. and less than or equal to 12×10⁻⁶/° C.

The electrolyte 22 is not particularly limited in method of formation, and hence, can be formed by any of the methods such as firing, spray coating, PVD, and CVD.

### <Reaction Preventing Layer>

The reaction preventing layer 23 is disposed between the electrolyte 22 and the oxygen electrode 24. The reaction preventing layer 23 is disposed on the opposite side of the side on which the hydrogen electrode 21 is disposed with reference to the electrolyte 22. The reaction preventing layer 23 inhibits a layer with high electric resistance from being formed by reactions between the element of which the electrolyte 22 is made and the element of which the oxygen electrode 24 is made.

The reaction preventing layer 23 is made of an oxide ionic conductive material. The reaction preventing layer 23 can be made of GDC, SDC, or so forth.

The reaction preventing layer 23 is not particularly limited in porosity, and hence, can be set to have a porosity of, for instance, greater than or equal to 0.1% and less than or equal to 50%. The reaction preventing layer 23 is not particularly limited in thickness, and hence, can be set to have a thickness of, for instance, greater than or equal to 1 μm and less than or equal to 50 μm.

The reaction preventing layer 23 is not particularly limited in method of formation, and hence, can be formed by any of the methods such as firing, spray coating, PVD, and CVD.

### <Oxygen Electrode>

The oxygen electrode 24 is disposed on the opposite side of the side on which the hydrogen electrode 21 is disposed with reference to the electrolyte 22. In the present preferred embodiment, the reaction preventing layer 23 is disposed between the electrolyte 22 and the oxygen electrode 24; hence, the oxygen electrode 24 is connected to the reaction preventing layer 23. When the reaction preventing layer 23 is not disposed between the electrolyte 22 and the oxygen electrode 24, the oxygen electrode 24 is connected to the electrolyte 22.

The oxygen electrode 24 generates O₂ from O²⁻ transmitted thereto from the hydrogen electrode 21 through the electrolyte 22 by chemical reactions expressed by the following formula (5).

Oxygen electrode24:2O²⁻→O₂+4e⁻ (5)

The oxygen electrode 24 is a porous body with oxide ionic conductivity and electronic conductivity. The oxygen electrode 24 can be made of, for instance, a composite material composed of an oxide ionic conductive material (GDC, etc.) and at least one selected from the group consisting of (La, Sr)(Co, Fe)O₃, (La, Sr)FeO₃, La(Ni, Fe)O₃, (La, Sr)CoO₃, and (Sm, Sr)CoO₃.

The oxygen electrode 24 is not particularly limited in porosity, and hence, can be set to have a porosity of, for instance, greater than or equal to 20% and less than or equal to 60%. The oxygen electrode 24 is not particularly limited in thickness, and hence, can be set to have a thickness of, for instance, greater than or equal to 1 μm and less than or equal to 100 μm.

The oxygen electrode 24 is not particularly limited in method of formation, and hence, can be formed by any of the methods such as firing, spray coating, PVD, and CVD.

### <Fluid Container>

As shown in FIG. 2, the fluid container 3 includes the internal space 30. The raw material gas to be supplied to the hydrogen electrode 21 and reducing gas (H₂ in the present preferred embodiment) to be generated in the hydrogen electrode 21 flow into the internal space 30. It should be noted that the raw material gas and the reducing gas are exemplary fluids of the present invention.

The fluid container 3 includes the metallic support 31 (exemplary first metallic member), a frame 32 (exemplary second metallic member), an inter-connector 33, a first adherence part 34 (exemplary adherence part), and a second adherence part 35. The internal space 30 is a space enclosed by the metallic support 31, the frame 32, the inter-connector 33, the first adherence part 34, and the second adherence part 35.

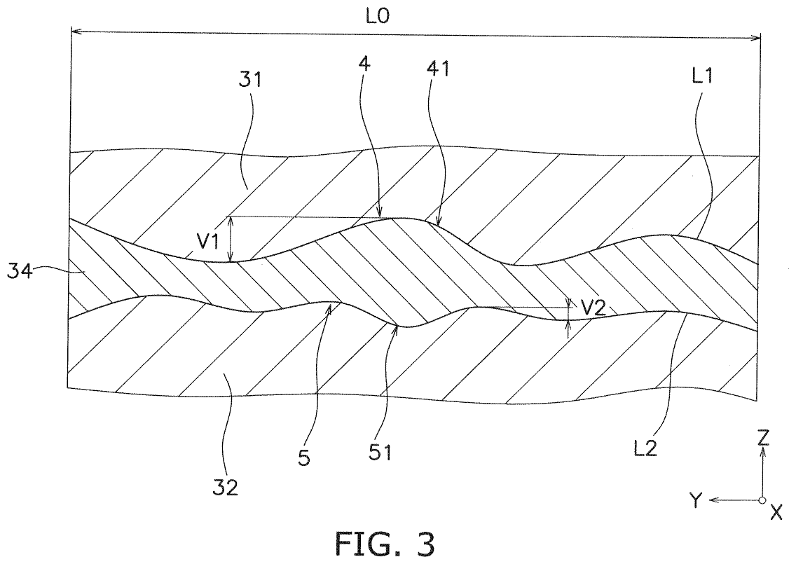

Besides, as shown in FIG. 3, the fluid container 3 includes a first interface 4 and a second interface 5. FIG. 3 is a cross-sectional view of FIG. 1 taken along line III-III and is also an enlarged cross-sectional view focusing on the first adherence part 34.

### <Metallic Support>

As shown in FIG. 2, the metallic support 31 supports the cell body 2. In the present preferred embodiment, the metallic support 31 is made in shape of a plate. Insomuch as the cell body 2 can be supported by the metallic support 31, the metallic support 31 is not particularly limited in thickness, and hence, can be set to have a thickness of, for instance, greater than or equal to 0.1 mm and less than or equal to 2.0 mm.

The metallic support 31 includes the plural communicating holes 313, the first principal surface 311, and a second principal surface 312.

Each communicating hole 313 penetrates the metallic support 31 from the first principal surface 311 to the second principal surface 312. Each communicating hole 313 is opened on each of the first and second principal surfaces 311 and 312. Each communicating hole 313 is covered with the cell body 2. Specifically, the first principal surface 311-side opening of each communicating hole 313 is covered with the hydrogen electrode 21. The second principal surface 312-side opening of each communicating hole 313 continues to the internal space 30.

Each communicating hole 313 can be formed by machining processing (e.g., punching), laser processing, chemical processing (e.g., etching), or so forth.

In the present preferred embodiment, each communicating hole 313 is shaped straight along the Z-axis direction. However, each communicating hole 313 may slant with respect to the Z-axis direction; besides or alternatively, each communication hole 313 may not be shaped straight. Besides or alternatively, the communicating holes 313 may continue to each other.

The first principal surface 311 is provided on the opposite side of the second principal surface 312. The cell body 2 is disposed on the first principal surface 311. The frame 32 is joined to the second principal surface 312 through the first adherence part 34.

The metallic support 31 is made of an alloy containing Cr (Chromium). Fe—Cr-based alloy steel (stainless steel, etc.), Ni—Cr-based alloy steel, or so forth can be exemplified as the alloy herein described. The metallic support 31 is not particularly limited in content rate of Cr, and hence, can be set to contain Cr at a content rate of greater than or equal to 4 mass % and less than or equal to 30 mass %.

The metallic support 31 may contain Ti (Titanium) and Zr (Zirconium). The metallic support 31 is not particularly limited in content rate of Ti, and hence, can be set to contain Ti at a content rate of greater than or equal to 0.01 mol % and less than or equal to 1.0 mol %. The metallic support 31 is not particularly limited in content rate of Zr, and hence, can be set to contain Zr at a content rate of greater than or equal to 0.01 mol % and less than or equal to 0.4 mol %. The metallic support 31 may contain Ti in the form of TiO₂ (titania) and may contain Zr in the form of ZrO₂ (zirconia).

### <Frame>

The frame 32 is a spacer for forming the internal space 30. The frame 12 is annularly shaped in a plan view (seen in the Z-axis direction). The frame 32 is joined to the metallic support 31 through the first adherence part 34, while being joined to the inter-connector 33 through the second adherence part 35. The frame 32 is not particularly limited in thickness, and hence, can be set to have a thickness of, for instance, greater than or equal to 0.1 mm and less than or equal to 2.0 mm.

The frame 32 includes a first principal surface 321 and a second principal surface 322. The first principal surface 321 of the frame 32 is a surface facing the metallic support 31. The second principal surface 322 of the frame 32 is a surface facing the inter-connector 33.

The frame 32 is made of an alloy containing Cr. Fe—Cr-based alloy steel, Ni—Cr-based alloy steel, or so forth can be exemplified as the alloy herein described. The frame 32 is not particularly limited in content rate of Cr, and hence, can be set to contain Cr at a content rate of greater than or equal to 4 mass % and less than or equal to 30 mass %. The frame 32 may be identical in composition to or different in composition from the metallic support 31.

### <Inter-Connector>

The inter-connector 33 is disposed on the opposite side of the side on which the metallic support 31 is disposed with reference to the frame 32. The inter-connector 33 is a member for electrically connecting the electrolytic cell 100 to either an external power source or another electrolytic cell.

The inter-connector 33 is made in shape of a plate. The inter-connector 33 is joined to the frame 32 through the second adherence part 35. The inter-connector 33 is not particularly limited in thickness, and hence, can be set to have a thickness of, for instance, greater than or equal to 0.1 mm and less than or equal to 2.0 mm.

The inter-connector 33 is made of an alloy containing Cr. Fe—Cr-based alloy steel, Ni—Cr-based alloy steel, or so forth can be exemplified as the alloy herein described. The inter-connector 33 is not particularly limited in content rate of Cr, and hence, can be set to contain Cr at a content rate of greater than or equal to 4 mass % and less than or equal to 30 mass %. The inter-connector 33 may be identical in composition to or different in composition from the metallic support 31. The inter-connector 33 may be identical in composition to or different in composition from the frame 32.

### <First Adherence Part>

The first adherence part 34 is disposed between the metallic support 31 and the frame 32. The first adherence part 34 adheres the metallic support 31 and the frame 32 to each other. When described in detail, the first adherence part 34 is joined to each of the metallic support 31 and the frame 32.

The first adherence part 34 seals a gap between the metallic support 31 and the frame 32. Accordingly, the raw material gas to be supplied to the hydrogen electrode 21 and the reducing gas to be generated in the hydrogen electrode 21 can be prevented from leaking out through the gap between the metallic support 31 and the frame 32.

The first adherence part 34 is disposed between the metallic support 31 and the frame 32. The first adherence part 34 is interposed between the metallic support 31 and the frame 32. The first adherence part 34 annularly extends to enclose the internal space 30. The first adherence part 34 functions as a seal for sealing the internal space 30. In other words, the first adherence part 34 annularly extends in a continuous manner.

The first adherence part 34 is made of an oxide containing Cr as a primary component (hereinafter abbreviated as “Cr oxide”). Accordingly, during manufacturing or operating the electrolytic cell 100, Cr can be inhibited from diffusing from the metallic support 31 and the frame 32 to the first adherence part 34. Besides, even if Cr diffuses from the metallic support 31 and the frame 32 to the first adherence part 34, the diffused Cr is not so much as affecting the composition of the first adherence part 34; hence, deterioration in strength of the first adherence part 34 can be inhibited as well. Furthermore, the metallic support 31, the frame 32, and the first adherence part 34 contain Cr in common, whereby adherence property can be enhanced among the metallic support 31, the frame 32, and the first adherence part 34. Therefore, adherence property of the metallic support 31 and the frame 32 can be maintained over a long period of time.

It should be noted that in the present preferred embodiment, “the Cr oxide, of which the first adherence part 34 is made, contains Cr as the primary component” means that Cr is the highest in content rate among metallic elements of the Cr oxide when the composition of the Cr oxide is analyzed by an energy dispersive spectrometer (EDS). The Cr oxide is not particularly limited in content rate of Cr among the metallic elements, and hence, can be set to contain Cr at a content rate of, for instance, greater than or equal to 20 mol % and less than or equal to 100 mol %.

The Cr oxide, of which the first adherence part 34 is made, preferably contains Cr among the metallic elements thereof at a content rate of greater than or equal to 50 mol %. Accordingly, Cr contained in the metallic support 31 and the frame 32 can be remarkably inhibited from being diffused to the first adherence part 34.

The Cr oxide, of which the first adherence part 34 is made, is preferably composed of at least either chromium oxide or chromium manganese oxide. The oxides herein described have properties that Cr is especially unlikely to diffuse; hence, the first adherence part 34 can be thereby enhanced in durability.

Cr₂O₃ or so forth can be exemplified as the chromium oxide. MnCr₂O₄ (spinel), Mn_{1.5}Cr_{1.5}O₄ (spinel), or so forth can be exemplified as the chromium manganese oxide.

The Cr oxide, of which the first adherence part 34 is made, is preferably crystalline. Because of this, even if the electrolytic cell 100 is operated for a long period of time, it is made possible to avoid occurrence of such a situation that the Cr oxide transitions from a non-crystalline phase to a crystalline phase, whereby the first adherence part 34 is undesirably damaged or broken.

The Cr oxide, of which the first adherence part 34 is made, preferably has either a spinel crystal structure or a corundum crystal structure. The crystal structures herein described are high in symmetry; hence, the first adherence part 34 can be thereby enhanced in endurance against thermal stress.

The first adherence part 34 can be formed by applying a paste containing the Cr oxide onto at least either the surface of the metallic support 31 or that of the frame 32, and then, by conducting a thermal treatment in a state that the metallic support 31 and the frame 32 are closely contacted to each other. Conditions for the thermal treatment can be arbitrarily set but the following can be set as exemplary conditions for the thermal treatment: a temperature of greater than or equal to 600° C. and less than or equal to 1100° C. and a duration of greater than or equal to 0.5 hours and less than or equal to 24 hours.

### <Second Adherence Part>

The second adherence part 35 is disposed between the frame 32 and the inter-connector 33. The second adherence part 35 adheres the frame 32 and the inter-connector 33 to each other. When described in detail, the second adherence part 35 is joined to each of the frame 32 and the inter-connector 33.

The second adherence part 35 seals a gap between the frame 32 and the inter-connector 33. Accordingly, the raw material gas to be supplied to the hydrogen electrode 21 and the reducing gas to be generated in the hydrogen electrode 21 are prevented from being leaked out through the gap between the frame 32 and the inter-connector 33.

The second adherence part 35 is substantially identical in configuration to the first adherence part 34 described above; hence, in the present preferred embodiment, explanation will be omitted for the configuration of the second adherence part 35.

### <First and Second Interfaces>

As shown in FIG. 3, the first interface 4 is an interface between the metallic support 31 and the first adherence part 34. The first interface 4 includes one or more first wavy portions 41. Each of the one or more first wavy portions 41 is configured to repeatedly wind in a thickness direction (Z-axis direction). In other words, each first wavy portion 41 is composed of protrusions protruding toward the metallic support 31 (upward in FIG. 3) and recesses recessed toward the first adherence part 34 (downward in FIG. 3). The protrusions and recesses, composing each first wavy portion 41, are alternately aligned along the outer peripheral edge of the metallic support 31.

The second interface 5 is an interface between the frame 32 and the first adherence part 34. The second interface 5 includes one or more second wavy portions 51. Each of the one or more second wavy portions 51 is configured to repeatedly wind the thickness direction (Z-axis direction). In other words, each second wavy portion 51 is composed of protrusions protruding toward the first adherence part 34 (upward in FIG. 3) and recesses recessed toward the frame 32 (downward in FIG. 3). The protrusions and recesses, composing each second wavy portion 51, are alternately aligned along the outer peripheral edge of the frame 32.

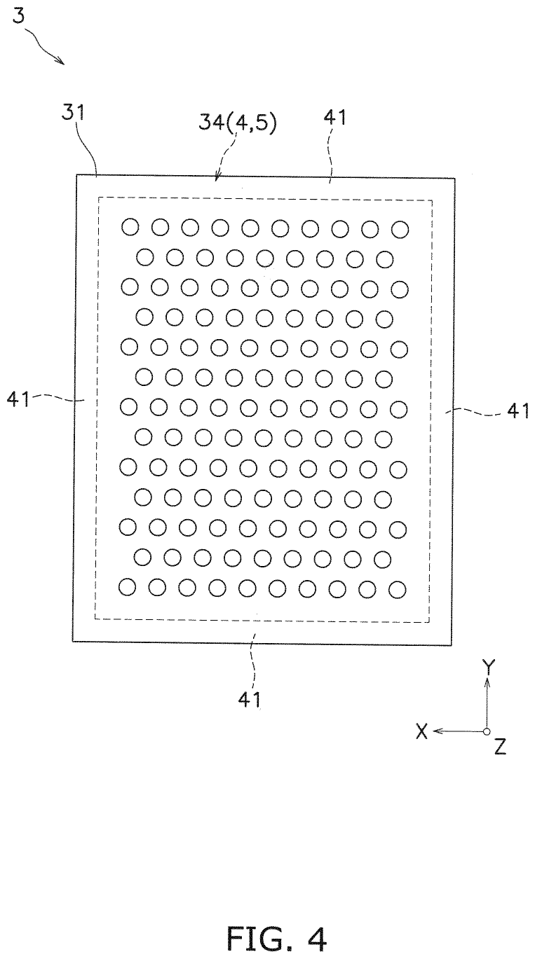

FIG. 4 is a plan view of the fluid container 3. As shown in FIG. 4, in the plan view (seen in the Z-axis direction), the first adherence part 34 includes one or more straight portions. In other words, in the plan view, each of the first and second interfaces 4 and 5 includes one or more straight portions. It should be noted that in the present preferred embodiment, each of the first and second interfaces 4 and 5 includes four straight portions. When described in detail, each of the first and second interfaces 4 and 5 includes a pair of straight portions extending in the X-axis direction and a pair of straight portions extending in the Y-axis direction. In the plan view, each of the first and second interfaces 4 and 5 extends in a rectangular shape.

The first wavy portions 41 are provided as the straight portions, respectively. In other words, the straight portions are composed of the four first wavy portions 41. In other words, the first wavy portions 41 are provided over the entire circumference of the first interface 4.

As shown in FIG. 3, in at least one of the first wavy portions 41, an amount of variation V1 can be set to be greater than or equal to 1 μm and less than or equal to 50 μm. It should be noted that the amount of variation V1 in each first wavy portion 41 can be measured as follows. First, given one of the first wavy portions 41, set as a measurement object, is cut to create a cross section along the extending direction thereof. The cross section is created in the middle of the given first wavy portion 41 in a width direction. It should be noted that the width direction of the given first wavy portion 41 is a direction orthogonal to the extending direction of the given first wavy portion 41. For example, the width direction of the given first wavy portion 41 extending in the X-axis direction corresponds to the Y-axis direction, whereas the width direction of the given first wavy portion 41 extending in the Y-axis direction corresponds to the X-axis direction.

Then, the cross section is scanned (photographed) by a scanning electron microscopy (SEM) at a 1000- to 10000-fold magnification. It is preferable for the given first wavy portion 41 to be entirely shown in an image herein photographed. If the given first wavy portion 41 cannot be entirely shown within the single photographed image, a plurality of images are photographed such that the given first wavy portion 41 can be entirely shown.

Subsequently, a moving average line of the given first wavy portion 41 is created as a preprocessing for measurement. When described in detail, height directional (Z-axis directional) coordinates of the first interface 4 are measured along the extending direction of the given first wavy portion 41 in measurement points set at intervals of 10 μm and an average of the height directional coordinates in adjacent 10 measurement points is set as the height in the middle of the adjacent 10 measurement points (the middle of the fifth and sixth measurement points). This operation is performed by sequentially shifting the adjacent 10 measurement points by one point, whereby the moving average line of the given first wavy portion 41 is created as shown in FIG. 3.

Based on the moving average line of the given first wavy portion 41 created as described above, a difference in position between apices of each adjacent pair of protrusion and recess is measured as a value of the amount of variation V1 in the given first wavy portion 41 by an image analysis, whereby an average of differences measured as values of the amount of variation V1 can be set as the amount of variation V1 in the given first wavy portion 41. In the present preferred embodiment, four first wavy portions 41 exist; hence, four amounts of variation V1 can be calculated.

The amount of variation is greater at the outer peripheral edge than at the inner peripheral edge in the given first wavy portion 41. When the amount of variation is measured at the outer peripheral edge in the given first wavy portion 41, the cross section is created on the outer peripheral edge side of the width directional middle in the given first wavy portion 41. Contrarily, when the amount of variation is measured at the inner peripheral edge in the given first wavy portion 41, the cross section is created on the inner peripheral edge side of the width directional middle in the given first wavy portion 41.

A ratio (L1/L0) of the actual length (L1) of each first wavy portion 41 to the end-to-end distance (L0) of each first wavy portion 41 can be set to be, for instance, greater than or equal to 1.01 and less than or equal to 3.00. It should be noted that the ratio (L1/L0) of each first wavy portion 41 herein described can be measured based on the moving average line for each first wavy portion 41 described above. Specifically, the end-to-end distance and the actual distance of each first wavy portion 41 are measured within the photographed image; then, the ratio is calculated based on the measured values.

The second wavy portions 51 are provided as the straight portions, respectively. In other words, the straight portions are composed of four second wavy portions 51. In other words, the second wavy portions 51 are provided over the entire circumference of the second interface 5.

In at least one of the second wavy portions 51, an amount of variation V2 can be set to be greater than or equal to 1 μm and less than or equal to 50 μm. It should be noted that the amount of variation V2 in each second wavy portion 51 can be calculated based on the photographed image described above in a comparable method to calculating the amount of variation V1 in each first wavy portion 41. Specifically, a moving average line is created for each second wavy portion 51; then, a difference in position between apices of each adjacent pair of protrusion and recess is measured as a value of the amount of variation V2 in each second wavy portion 51 in the moving average line of each second wavy portion 51; finally, an average of differences measured as values of the amount of variation V2 can be set as the amount of variation V2 in each second wavy portion 51. In the present preferred embodiment, four second wavy portions 51 exist; hence, four amounts of variation V2 can be calculated.

The amount of variation is greater at the outer peripheral edge than at the inner peripheral edge in each second wavy portion 51. When the amount of variation is measured at the outer peripheral edge in each second wavy portion 51, the cross section is created on the outer peripheral edge side of the width directional middle in each second wavy portion 51. Contrarily, when the amount of variation is measured at the inner peripheral edge in each second wavy portion 51, the cross section is created on the inner peripheral edge side of the width directional middle in each second wavy portion 51.

A ratio (L2/L0) of the actual length (L2) of each second wavy portion 51 to the end-to-end distance (L0) of each second wavy portion 51 can be set to be, for instance, greater than or equal to 1.01 and less than or equal to 3.00. It should be noted that the ratio (L2/L0) of each second wavy portion 51 herein described can be measured based on the moving average line of each second wavy portion 51 described above.

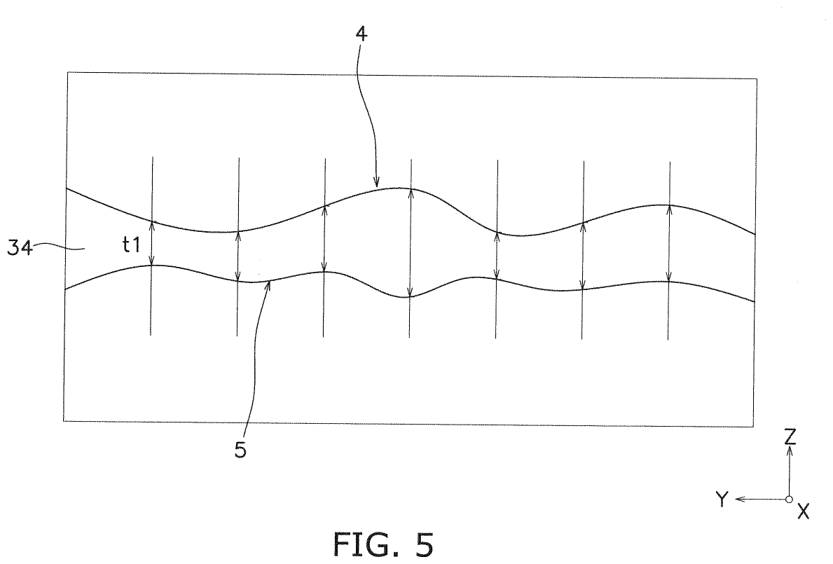

The first adherence part 34 is not particularly limited in thickness, and hence, can be set to have a thickness (t1) of, for instance, greater than or equal to 1 μm and less than or equal to 100 μm. The thickness t1 of the first adherence part 34 refers to a distance between the first interface 4 and the second interface 5. The thickness t1 of the first adherence part 34 can be measured based on the moving average lines of the first and second wavy portions 41 and 51 described above. Specifically, as shown in FIG. 5, values of the thickness t1 of the first adherence part 34 are measured at measurement points set to equally divide the moving average lines of the first and second wavy portions 41 and 51 into eight sections in the extending direction of the first adherence part 34, whereby an average of the measured values can be set as the thickness t1 of the first adherence part 34. A ratio (t2/t1) of the thickness (t2) of the metallic support 31 to the thickness (t1) of the first adherence part 34 can be set to be, for instance, less than or equal to 500.

### <Manufacturing Method>

A method of manufacturing the first interface 4, the second interface 5, and the first adherence part 34 will be hereinafter explained. First, bending such as stamping is conducted for the metallic support 31, whereby a region adhered to the first adherence part 34 (i.e., a region composing part of the first interface 4) on the second principal surface 312 of the metallic support 31 is made in such a wavy shape as described above. It should be noted that the region can be also made in such a wavy shape as described above when the metallic support 31 is processed to be reduced in thickness by conducting cutting, etching, laser abrasion, or so forth for the second principal surface 312.

Likewise, bending such as stamping is conducted for the frame 32, whereby a region adhered to the first adherence part 34 (i.e., a region composing part of the second interface 5) on the first principal surface 321 of the frame 32 is made in such a wavy shape as described above.

Then, the first adherence part 34 can be formed by applying a paste containing crystalline metallic oxide to at least either the surface of the metallic support 31 or that of the frame 32, and then, by conducting a thermal treatment in a state that the metallic support 31 and the frame 32 are closely contacted to each other. Conditions for the thermal treatment can be arbitrarily set. For example, the following can be set as the conditions for the thermal treatment: a temperature of greater than or equal to 600° C. and less than or equal to 1100° C. and a duration of greater than or equal to 0.5 hours and less than or equal to 24 hours.

### Modifications of Preferred Embodiment

One preferred embodiment of the present invention has been explained above. However, the present invention is not limited to this, and a variety of changes can be made without departing from the gist of the present invention.

(a) In the preferred embodiment described above, the frame 32 and the inter-connector 33 are provided as separate members but may be provided as an integrated member. In this case, the fluid container 3 does not include the second adherence part 35.

(b) In the preferred embodiment described above, the metallic support 31 and the frame 32 are provided as separate members but may be provided as an integrated member. In this case, the fluid container 3 does not include the first adherence part 34.

(c) In the preferred embodiment described above, the metallic support 31 is exemplified as the first metallic member, whereas the frame 32 is exemplified as the second metallic member; however, the fluid container 3 is not limited in configuration to this. For example, the frame 32 may be exemplified as the first metallic member, whereas the metallic support 31 may be exemplified as the second metallic member.

(d) In the preferred embodiment described above, the first interface 4 is provided with the first wavy portions 41 over the entire circumference thereof but is not limited in configuration to this. For example, among the four straight portions included in the first interface 4, only one straight portion may take the form of the first wavy portion 41, whereas the remaining straight portions may be made in a planar shape not in a wavy shape. When described in detail, among the four straight portions, the one, on which a stress is likely to act, may take the form of the first wavy portion 41. Besides, as to the straight portion taking the form of the first wavy portion 41, the entirety thereof is not required to take the form of the first wavy portion 41 and only part thereof may take the form of the first wavy portion 41. It should be noted that the configuration herein described is also true of the second interface 5.

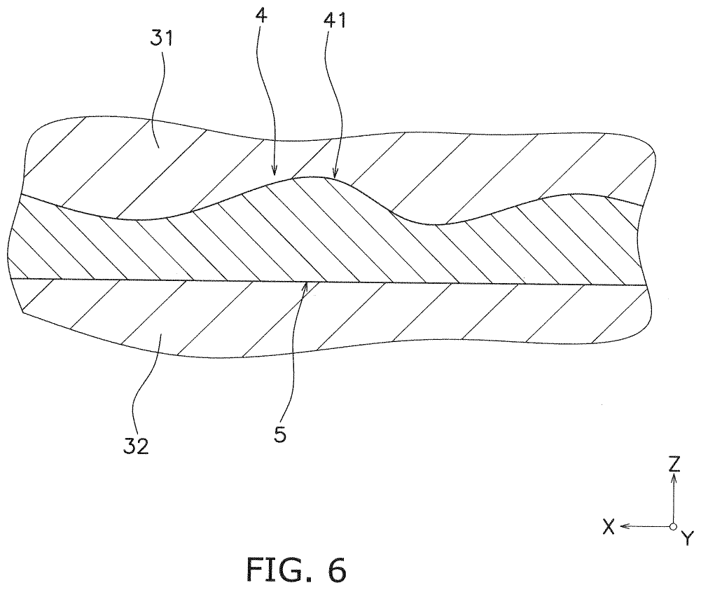

(e) The second interface 5 may not include the at least one second wavy portion 51. Specifically, as shown in FIG. 6, only the first interface 4 may include the at least one first wavy portion 41.

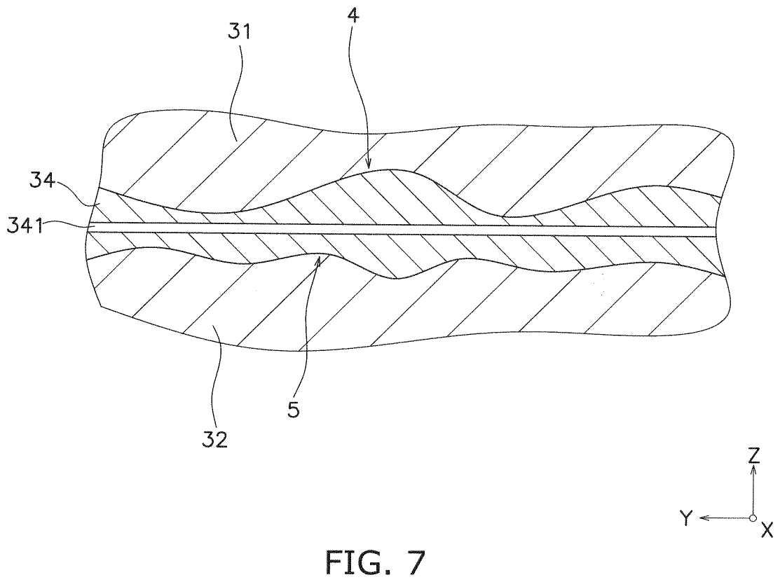

(f) As shown in FIG. 7, the first adherence part 34 may include an unfilled portion 341 in the interior thereof. In this case, the unfilled portion 341 is provided not entirely but in part in the width direction (the X-axis direction in FIG. 7).

(g) In the preferred embodiment described above, the electrochemical cell is exemplified by the electrolytic cell but is not limited thereto. The electrochemical cell is a generic term for referring to an element for changing electric energy into chemical energy, in which a pair of electrodes is disposed to generate an electromotive force from entire oxidoreduction reactions, and an element for changing chemical energy into electric energy. Therefore, a fuel cell, in which oxide ions or protons act as carriers, is considered as the electrochemical cell.

(h) The preferred embodiment described above has been explained as the embodiment that the fluid container according to the present invention is applied to the electrochemical cell; however, the fluid container is usable for a variety of applications. The fluid container is applicable to, for instance, a reactor for methanation to synthesize methane from hydrogen and carbon dioxide.

### Practical Example

A practical example of the present invention will be hereinafter explained. However, the present invention is not limited to the practical example to be hereinafter explained.

Twenty-one electrolytic cells 100, configured as shown in FIG. 2, are fabricated. When described in detail, NiO-GDC (porous rate: 35%, thickness: 25 μm, thermal expansion rate: 12.7 ppm/K) was used as the material of the hydrogen electrode 21; YSZ (porous rate: 0.6%, thickness: 8 μm, thermal expansion rate: 10.0 ppm/K) was used as the material of the electrolyte 22; GDC (porous rate: 25%, thickness: 8 μm, thermal expansion rate: 12.3 ppm/K) was used as the material of the reaction preventing layer 23; LSCF (porous rate: 45%, thickness: 30 μm, thermal expansion rate: 15.0 ppm/K) was used as the material of the oxygen electrode 24. It should be noted that the cell body 2 was set to have an external dimension of 130 mm×130 mm. Crofer 22 APU (external dimension: 150 mm×150 mm, thickness: 200 μm, thermal expansion rate: 12.7 ppm/K) was used as the material of the metallic support 31, the frame 32, and the inter-connector 33. It should be noted that the frame 32 was set to have an internal dimension of 130 mm×130 mm. Chromium oxide was used as the material of the first and second adherence parts 34 and 35.

The electrolytic cells 100 were fabricated to be different from each other regarding the configuration of the amount of variation in the first wavy portion 41 of the first adherence part 34 and that in the second wavy portion 51 of the first adherence part 34. The amount of variation in the first wavy portion 41 and that in the second wavy portion 51 were obtained as shown in Table 1. It should be noted that in the electrolytic cells 100 assigned with Nos. 1 and 2, the second interface 5 did not include the second wavy portion 51. On the other hand, in the electrolytic cell 100 assigned with No. 21, the first interface 4 did not include the first wavy portion 41; likewise, the second interface 5 did not include the second wavy portion 51. It should be noted that the conditions other than the amount of variation were set identical among the electrolytic cells 100.

### <Assessment Method>

A thermal cycle test was conducted for each of the electrolytic cells 100 to examine whether peeling and cracking occurred in the first adherence part 34. Specifically, each electrolytic cell 100 was set in an electric furnace and the temperature was repeatedly increased and decreased from the room temperature to 800° C. and vice versa ten times at a temperature increase/decrease speed of 200° C./hr. Thereafter, each electrolytic cell 100 was taken out of the electric furnace and examined whether peeling and cracking occurred in the first adherence part 34. An external inspection was conducted to examine whether peeling occurred. On the other hand, an SEM observation was conducted at a 5000-fold magnification to examine whether cracking occurred. Results of the examinations are shown in Table 1.

TABLE 1

| | AMOUNT OF | | AMOUNT OF | | | |
|---|---|---|---|---|---|---|
| | VARIATION IN | | VARIATION IN | | | |
| | FIRST WAVY | | SECOND WAVY | | RESULTS | |
| No. | PORTION | | PORTION | | PEELING | MINUTE CRACK |
| 1 | 0.5 | μ m | 0 | μ m | OCCURRED IN PART | — |
| 2 | 75 | μ m | 0 | μ m | OCCURRED IN PART | — |
| 3 | 1 | μ m | 0.5 | μ m | NOT OCCURRED | OCCURRED |
| 4 | 1 | μ m | 75 | μ m | NOT OCCURRED | OCCURRED |
| 5 | 10 | μ m | 0.5 | μ m | NOT OCCURRED | OCCURRED |
| 6 | 10 | μ m | 75 | μ m | NOT OCCURRED | OCCURRED |
| 7 | 25 | μ m | 0.5 | μ m | NOT OCCURRED | OCCURRED |
| 8 | 25 | μ m | 75 | μ m | NOT OCCURRED | OCCURRED |
| 9 | 50 | μ m | 0.5 | μ m | NOT OCCURRED | OCCURRED |
| 10 | 50 | μ m | 75 | μ m | NOT OCCURRED | OCCURRED |
| 11 | 1 | μ m | 1 | μ m | NOT OCCURRED | NOT OCCURRED |
| 12 | 1 | μ m | 10 | μ m | NOT OCCURRED | NOT OCCURRED |
| 13 | 1 | μ m | 25 | μ m | NOT OCCURRED | NOT OCCURRED |
| 14 | 1 | μ m | 50 | μ m | NOT OCCURRED | NOT OCCURRED |
| 15 | 10 | μ m | 10 | μ m | NOT OCCURRED | NOT OCCURRED |
| 16 | 10 | μ m | 25 | μ m | NOT OCCURRED | NOT OCCURRED |
| 17 | 10 | μ m | 50 | μ m | NOT OCCURRED | NOT OCCURRED |
| 18 | 25 | μ m | 25 | μ m | NOT OCCURRED | NOT OCCURRED |
| 19 | 25 | μ m | 50 | μ m | NOT OCCURRED | NOT OCCURRED |
| 20 | 50 | μ m | 50 | μ m | NOT OCCURRED | NOT OCCURRED |
| 21 | 0 | μ m | 0 | μ m | OCCURRED ENTIRELY | — |

### <Assessment Result>

As shown in Table 1, it was found that occurrence of peeling could be prevented or inhibited to a partial extent in the first adherence part 34 when at least either of the first and second interfaces 4 and 5 included the wavy portion. Besides, it was found that occurrence of peeling could be prevented in the first adherence part 34 when at least either of the first and second interfaces 4 and 5 included the wavy portion, in which the amount of variation was set to fall in a range of 1 to 50 μm. Furthermore, it was found that not only occurrence of peeling but also occurrence of a minute crack could be prevented in the first adherence part 34 when the first interface 4 included the first wavy portion 41, in which the amount of variation was set to fall in a range of 1 to 50 μm, while the second interface 5 included the second wavy portion 51, in which the amount of variation was set to fall in a range of 1 to 50 μm.

### REFERENCE SIGNS LIST

2: Cell body
3: Fluid container
30: Internal space
31: Metallic support
32: Frame
34: First adherence part
4: First interface
41: First wavy portion
5: Second interface
51: Second wavy portion
100: Electrolytic cell

1. A fluid container comprising:
a first metallic member containing chromium;
a second metallic member containing chromium;
an adherence part made of an oxide containing chromium as a primary component, the adherence part adhering the first and second metallic members to each other;
a first interface provided as an interface between the first metallic member and the adherence part; and
a second interface provided as an interface between the second metallic member and the adherence part, wherein
the first interface includes a first wavy portion, the first wavy portion repeatedly winding in a thickness direction thereof, the first wavy portion extending along an outer peripheral edge of the first metallic member.

2. The fluid container according to claim 1, wherein the second interface includes a second wavy portion, the second wavy portion repeatedly winding in a thickness direction thereof, the second wavy portion extending along an outer peripheral edge of the second metallic member.

3. The fluid container according to claim 1, wherein the first wavy portion is greater in amount of variation at an outer peripheral edge thereof than at an inner peripheral edge thereof.

4. The fluid container according to claim 1, wherein the first adherence part includes an unfilled portion.

5. The fluid container according to claim 1, wherein the first wavy portion has an amount of variation of greater than or equal to 1 μm and less than or equal to 50 μm.

6. The fluid container according to claim 2, wherein
the first wavy portion has an amount of variation of greater than or equal to 1 μm and less than or equal to 50 μm, and
the second wavy portion has an amount of variation of greater than or equal to 1 μm and less than or equal to 50 μm.

7. The fluid container according to claim 1, further comprising:
an internal space through which a fluid flows, wherein
the adherence part annularly extends to enclose the internal space.

8. The fluid container according to claim 1, further comprising:
an internal space through which a fluid flows, wherein
the adherence part is a seal for sealing the internal space.

9. An electrochemical cell comprising:
the fluid container recited in claim 1; and
a cell body disposed on the fluid container.

10. The electrochemical cell according to claim 9, wherein
the fluid container includes an internal space through which a fluid flows,
the first metallic member includes a plurality of communicating holes continuing to the internal space, and
the cell body is disposed on the first metallic member to cover the plurality of communicating holes.

11. The electrochemical cell according to claim 9, wherein
the fluid container includes an internal space through which a fluid flows,
the second metallic member includes a plurality of communicating holes continuing to the internal space, and
the cell body is disposed on the second metallic member to cover the plurality of communicating holes.
